(19) United States
(12) Patent Application Publication
(10) Pub. No.: US 2013/0184876 A1
(43) Pub. Date: Jul. 18, 2013

(54) Managing Power Consumption In A User Space

(71) Applicants: Waseem A. Roshen, Hilliard, OH (US); Nadeem Malik, Austin, TX (US)

(72) Inventors: Waseem A. Roshen, Hilliard, OH (US); Nadeem Malik, Austin, TX (US)

(73) Assignee: INTERNATIONAL BUSINESS MACHINES CORPORATION, Armonk, NY (US)

(21) Appl. No.: 13/349,238

(22) Filed: Jan. 12, 2012

(51) Int. Cl. G06F 1/32; G05D 23/19

(52) U.S. Cl. 700/277

(57) ABSTRACT

Managing power consumption in a user space that includes user devices and motion detectors includes monitoring user presence within the space including: monitoring the user devices for user activity, where user activity indicates user presence within the space; and monitoring the motion detectors for user movement, where user movement indicates user presence within the space; if the user devices and motion detectors indicate no user presence within the space, setting one or more environmental control devices to a reduced power consumption state; and if the user devices and motion detectors indicate user presence within the space, setting the one or more environmental control devices to operate in a user-present power consumption state.

### BACKGROUND OF THE INVENTION

1. Field of the Invention

The field of the invention is data processing, or, more specifically, methods, apparatus, and products for managing power consumption in a user space.

2. Description Of Related Art

In many large office buildings as well as large industrial or commercial buildings, an entire building or a particular floor may be kept at a given temperature even when only a few employees are present in a few small areas, and in many cases, for small periods of time. This is a very common situation in the evenings or at night time, on the weekends, and holidays. This situation exists in spite of the fact that thermostats for HVAC (Heating, Ventilation, and Air Conditioning) system are typically located in such small areas. This is because currently there is no comprehensive method to detect the presence or absence of people in a given small area and then to set the temperature in the controller for that area accordingly. For example, in winter times if the temperature is set to 70 degrees during the day time and week days, the same temperature is often maintained in the evenings, holidays, nighttime, and weekends even when there are no employees present in that area of the building. As such, a large amount of electricity, gas, oil or other source of energy is wasted. Similarly in hot weather, such as summer season, there is no need to maintain the same daytime (weekdays) temperature in the evenings, night time, holidays, or weekends, if there are no people present in a given small area.

In a similar manner, in many large office buildings as well large business or commercial buildings, all lights for an entire building or a particular floor are kept on even when only a few of the employees are present in a few small areas, and in many cases, for small periods of time. This is a very common situation in the evenings or at night time, on the weekends, and holidays. This situation exists because the lights for a particular area of a building—a given floor or the building as a whole—are typically controlled from a single central location. Keeping lights on the for the whole floor or the whole building when the lights are needed only in a few small areas results in large amount of wasted power or electricity, which has an unnecessary negative effect on the environment as well as increased costs in energy consumption.

### SUMMARY OF THE INVENTION

Methods, apparatus, and products for managing power consumption in a user space are disclosed in this specification. The user space includes one or more user devices and one or more motion detectors. Managing power consumption in such a user space in accordance with embodiments of the present invention includes monitoring user presence within the space. Monitoring user presence includes monitoring the user devices for user activity, where user activity indicates user presence within the space, and monitoring the motion detectors for user movement, where user movement indicates user presence within the space. If the user devices and motion detectors indicate no user presence within the space, managing power consumption in a user space in accordance with embodiments of the present invention includes setting one or more environmental control devices to a reduced power consumption state. If the user devices and motion detectors indicate user presence within the space, managing power consumption in a user space in accordance with embodiments of the present invention includes setting the one or more environmental control devices to operate in a user-present power consumption state.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system for managing power consumption in a user space according to embodiments of the present invention.

FIG. 2 sets forth a flow chart illustrating an exemplary method for managing power consumption in a user space according to embodiments of the present invention.

FIG. 3 sets forth a flow chart illustrating a further exemplary method for managing power consumption in a user space according to embodiments of the present invention.

### DETAILED DESCRIPTION OF EXEMPLARY EMBODIMENTS

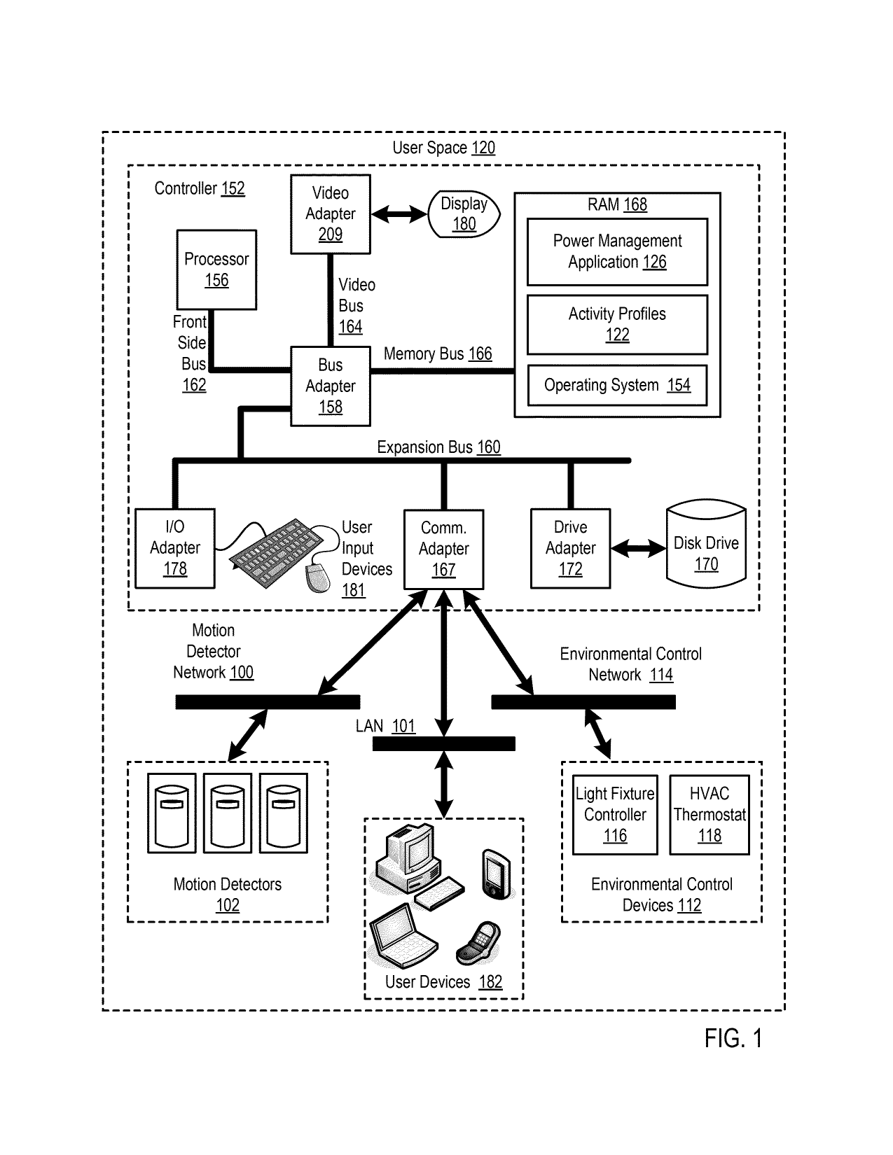

Exemplary methods, apparatus, and products for managing power consumption in a user space in accordance with the present invention are described with reference to the accompanying drawings, beginning with FIG. 1. FIG. 1 sets forth a block diagram of an example system for managing power consumption in a user space according to embodiments of the present invention. The term ‘user,’ when modifying the term ‘space’ in this specification, refers to a human being. A ‘user space’ as the term is used in this specification refers to any area, within which, a user may be located. Examples of user spaces include office buildings, industrial buildings, houses, data centers, and so on. A user in a user space embodied as an office building, for example, may be an employee of the company that rents or owns the office building.

The user space (120) of FIG. 1 also includes user devices (182). A ‘user device’ as the term is used in this specification is any module of automated computing machinery configured for operation by a user and for monitoring user activity. Personal desktop computers, workstations, servers, laptop computers, mobile communications devices, personal digital assistants, tablet computers, and so on are examples of user devices (182).

Each user device (182) in the example of FIG. 1 may include a module configured to detect or monitor user activity of the device. For example, a desktop or laptop computer may execute an Advanced Configuration and Power Interface (‘ACPI’) module that is configured to monitor user activity of the desktop or laptop computer and set the computer to operate in one of several power states in dependence upon the monitored user activity. When a user is inactive during a predefined period of time, for example, the ACPI module may place the desktop or laptop in a sleep state or hibernation.

The example user space (120) of FIG. 1 also includes motion detectors (102). A motion detector is a device for that detects detection. That is, a motion detector is a device that contains a physical mechanism or electronic sensor that quantifies motion. Motion detectors may be implemented in various forms including, for example:
Passive infrared sensors (Passive)—Looks for body heat. No energy is emitted from the sensor.
Ultrasonic (active)—Sends out pulses of ultrasonic waves and measures the reflection off a moving object.
Microwave (active)—Sensor sends out microwave pulses and measures the reflection off a moving object. Similar to a police radar detector.
Tomographic Detector (active)—Senses disturbances to radio waves as they travel through an area surrounded by mesh network nodes.

Motion detectors may be implemented as part of office security systems, in individual offices, utility room, server rooms, and so on as will occur to readers of skill in the art.

The system of FIG. 1 also includes environmental control devices (112). An environmental control device as the term is used in this specification refers to a device that controls environmental characteristics of the user space. Environmental characteristics may include lighting, temperature, humidity, airflow, and so on as will occur to readers of skill in the art. Examples of environmental control devices include light fixture controllers, HVAC thermostats, fan speed controllers, hygrometers that control humidifiers and de-humidifiers, and so on. The example user space (120) of FIG. 1 includes a light fixture controller (116) and an HVAC thermostat.

The user space (120) of FIG. 1 also includes automated computing machinery comprising an exemplary controller (152) useful in managing power consumption in a user space according to embodiments of the present invention. The controller (152) of FIG. 1 includes at least one computer processor (156) or ‘CPU’ as well as random access memory (168) (‘RAM’) which is connected through a high speed memory bus (166) and bus adapter (158) to processor (156) and to other components of the controller (152).

Stored in RAM (168) is a power management application (126), a module of computer program instructions that, when executed, cause the controller to manage power consumption in a user space according to embodiments of the present invention. The power management application (126) in the example of FIG. 1 operates generally for managing power in the user space by monitoring user presence within the space. Monitoring user presence within the user space (120) may be carried out by monitoring the user devices (182) for user activity and monitoring the motion detectors (102) for user movement. Both user activity of a user device (182) and user movement detected by a motion detector (102) indicates user presence within the space.

The power management application (126) may monitor the user devices (182) for user activity by monitoring user input device (181) activity of one or more computing devices and receiving, from each user device periodically during user activity of the user device, a device activity signal. Consider, for example, that each user device in the user space of FIG. 1 includes a keyboard or mouse through which a user may provide user input to software executing on the user device. Each user device may be configured to detect keyboard or mouse input as user activity and send a signal, through the local area network (‘LAN’) (101) to the controller (152), to indicate user activity. A user device may send such a signal as a ‘pulse’ periodically until user activity ceases. A user device, for example, may be configured to send, to the controller, a pulse once every second, beginning at an initial keystroke or mouse movement. The user device may be further configured to continue sending a pulse once every second to the controller until no keystroke or mouse movement is detected for ten minutes. When receiving the pulse signal, the power management application (126) may determine user presence in the space (120), while the loss of the signal may indicate to the power management application that no user is present in the space.

Readers of skill in the art will appreciate, that user devices such as desktop computers, laptop computers, mobile communications devices, PDAs, and so on typically include a communications adapter. In many cases, such communications adapters may operate on a wireless protocol. As such, modifying such user devices to report user device activity may be carried out by configuring the device to send a predefined device activity signal wirelessly.

In the same way, the power management application (126) may monitor the motion detectors for user movement by receiving, from each motion detection device during detection of user movement by the motion detection device, a motion activity signal. The motion detectors (102) may be configured to send a pulse—a signal—to the controller (152) upon detecting motion and cease sending the signal after a predetermined period of time without detecting motion. For example, the motion detector may be configured to send a pulse once every second upon detecting motion and cease sending a signal after one full minute of no motion.

The power management application (126) may be configured to recognize one or more user activity profiles (122). A user activity profile specifies associations of types of user presence and user device activity and motion detector data. Consider, for example, three distinct user activity profiles: a stationary user activity profile, a mobile user activity profile, and a user inactivity profile. A stationary user activity profile may specify expected motion detector and user device activity data that describes a stationary type of user activity. A user sitting at a desk while typing on a desktop computer, for example, may be relatively stationary, providing no motion detector data, but providing user device activity data. A mobile user activity profile may specify expected motion detector data and user device activity data that describe a mobile type of user activity. Several users in a conference room at an after-hours office party, for example, may provide significant motion detector data while providing relatively little device activity data. A user inactivity profile may specify expected user device activity and motion detector data describing limited or no user activity—no (or very little) user presence.

The power management application (126), in dependence upon the monitored user device activity and motion detectors, may determine a current user activity profile. If the power management application identifies an inactivity profile—a profile that indicates no user is (or relatively few users are) present in the user space—the power management application (126) sets one or more environmental control devices (112) to a reduced power consumption state. A ‘reduced power consumption state’ as the term is used here refers to a state of operation of a environmental control device in which the environmental control devices (‘ECDs’) or devices controlled by the ECDs consume less power relative to another state in which ECDs operate in light of user presence. Consider, for example, an office building on a hot, summer day, where the power management application (126) determines that no user is present in the office building. In such an example, the power management application (126) may set the environmental control devices (112) of the office building to a reduced power consumption state by setting the air conditioning thermostat to a higher temperature—say, 85 degrees Fahrenheit—and turn off all light fixtures in the office building.

If the power management application (126), however, determines that a user is present in the user space (120), the power management application (126) sets the one or more environmental control devices to operate in a user-present power consumption state. A user-present power consumption state is a state of operation of environmental control devices in which the ECDs operate in light of user presence. On a hot, summer day, for example the ECDs may operation in a user-present power consumption by the HVAC thermostat (118) being set to a target temperature of 72 degrees Fahrenheit and turning on, through use of the light fixture controller (116), all or some of the light fixtures in user space.

The power management application (126) may also operate without any activity profile at all. That is, the power management application (126) may be configured to allow the environmental control devices to operate in a user-present power consumption state until the loss of all activity and motion signals. A loss of all motion signals indicates no user movement while a loss of all activity signals indicates no user device activity at any user device in the user space. When no user movement is present in a user space and no device activity is occurring, it is likely that no user is present in an office space. As such, upon a loss of all activity and motion signals, the power management application (126) may immediately set the environmental control devices (112) to operate in the reduced power consumption mode—setting the HVAC thermostat's temperature, removing power from light fixtures, shutting down fans, turning off humidifiers and de-humidifiers, and so on

Also stored in RAM (168) is an operating system (154). Operating systems useful managing power consumption in a user space according to embodiments of the present invention include UNIX™, Linux™, Microsoft XP™, Microsoft 7™, AIX™, IBM's i5/OS™, and others as will occur to those of skill in the art. The operating system (154), power management application (126), activity profiles (122) and so on in the example of FIG. 1 are shown in RAM (168), but many components of such software typically are stored in non-volatile memory also, such as, for example, on a disk drive (170).

The controller (152) of FIG. 1 includes disk drive adapter (172) coupled through expansion bus (160) and bus adapter (158) to processor (156) and other components of the controller (152). Disk drive adapter (172) connects non-volatile data storage to the controller (152) in the form of disk drive (170). Disk drive adapters useful in controllers for managing power consumption in a user space according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example controller (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example controller (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary controller (152) of FIG. 1 includes a communications adapter (167) for data communications with other devices (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for managing power consumption in a user space according to embodiments of the present invention include modems for wired dial-up communications, Ethernet (IEEE 802.3) adapters for wired data communications network communications, and 802.11 adapters for wireless data communications network communications.

The example controller (152) of FIG. 1 is depicted as a complex computer system including many hardware and software computer components for comprehensive explanation only, not limitation. Readers of skill in the art will immediately recognize that such a controller may be implemented in a variety of ways. Other ways of implementing the example controller may be far less complex, include many fewer components, and be less costly overall. For example, a single microcontroller, a combination of digital logic, a programmed Field Programmable Gate Array, and the like may implement the above-described operations of the controller. Such a controller may be coupled to the motion detectors (102), user devices (182), and environmental control devices (112) through an out-of-band bus as simple as a 1-wire bus, and Inter Inter-Integrated Circuit (‘I²C’) bus, and RS485 bus and so on.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

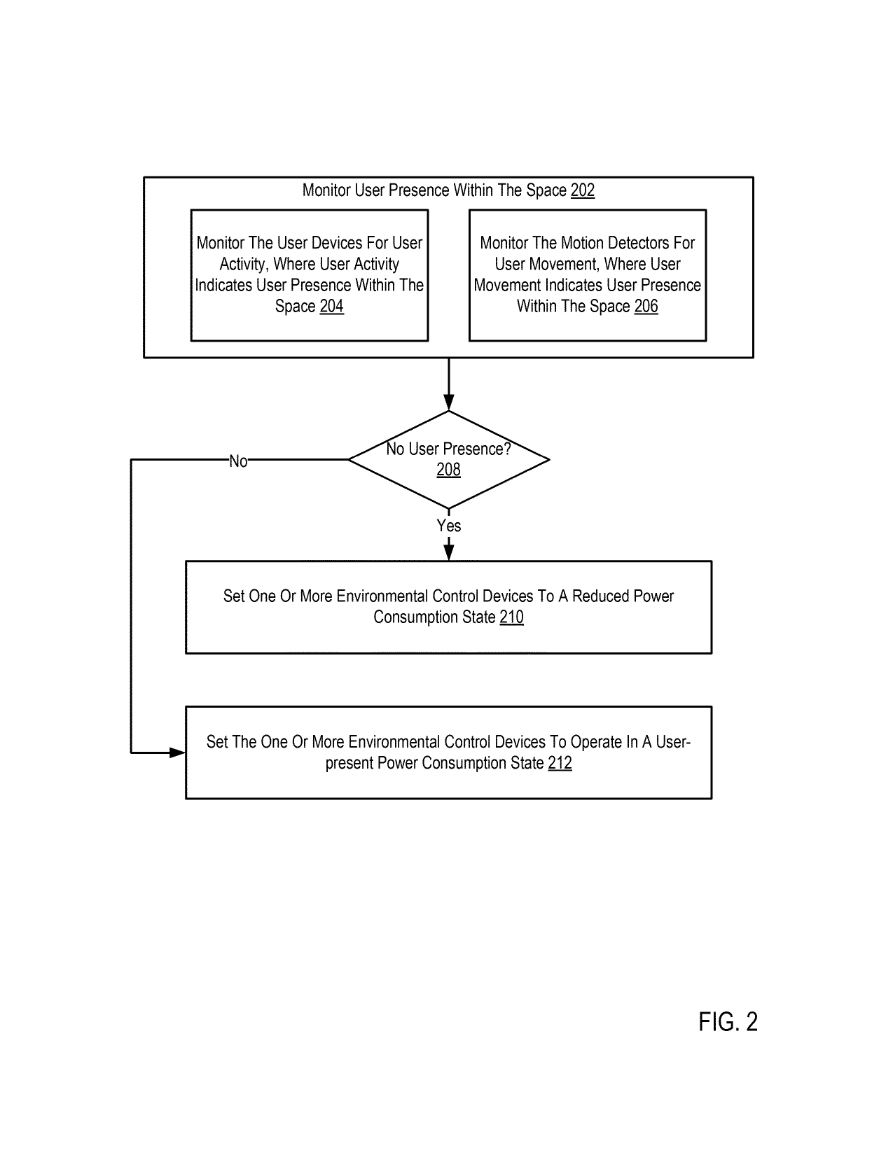

For further explanation, FIG. 2 sets forth a flow chart illustrating an exemplary method for managing power consumption in a user space according to embodiments of the present invention. The user space for which power consumption is managed in accordance with the method of FIG. 2 includes one or more user devices and one or more motion detectors. The method of FIG. 2 includes monitoring (202) user presence within the space. In the method of FIG. 2, monitoring (202) user presence within the space includes monitoring (204) the user devices for user activity and monitoring (206) the motion detectors for user movement. In the method of FIG. 2, user activity, monitored at the user devices, indicates user presence within the space and user movement, monitored at the motion detectors, indicates user presence within the space.

Monitoring (202) user presence within the space may be carried out by central controller, similar to the controller of FIG. 1. The controller may also be implemented with far fewer components than the controller depicted in FIG. 1. For example, the controller may be implemented as a microcontroller, FPGA, or other logic, programmed or configured to carry out the method of FIG. 2. Monitoring user presence—through user activity at user devices and user motion sensed by motion detectors—may be carried out by receiving signals from the user devices and motion sensors when activity is detected at a user device and motion is detected at a motion detector.

The method of FIG. 2 includes determining (208), in dependence upon the monitoring (204) of the user devices and the monitoring (206) of the motion detectors, whether there is no user present in the user space. The phrase ‘no user present’ may refer to exactly zero users present in a space or, in some embodiments, fewer than a predefined number of users present in a space. Consider, for example, that a user space, when operating in a reduced power consumption state, is configured to provide a relatively small amount of lighting and somewhat comfortable HVAC operation in a relatively small, predefined portion of the user space. In such an example, if the user device activity and motion detectors indicate a small amount of user presence in the predefined portion of the user space—say, one person in the one office or conference room—the controller may be configured to determine (208) that no user is present such that the reduced power consumption state is engaged as described below.

Although such a determination (208) may be carried out in many ways, the determination (208) in the example of FIG. 2 includes data from both the user devices and motion detectors. Unlike prior art systems that only focus on one type of data, the method of FIG. 2 enables a comprehensive method of managing power consumption in a user space by incorporate disparate types of user activity detection—specifically, in this example, user device activity and motion detector activity.

If the user devices and motion detectors indicate no user presence within the space, the method of FIG. 2 continues by setting (210) one or more environmental control devices to a reduced power consumption state. If the user devices and motion detectors indicate user presence within the space, the method of FIG. 2 continues by setting (212) the one or more environmental control devices to operate in a user-present power consumption state. Setting (210) environmental control devices to a reduced power consumption state may be carried out in various ways including, for example, signaling a light fixture controller to remove power from light fixtures and signaling a thermostat to set a predefined control temperature so as to reduce operation of an HVAC system. Setting (212) the environmental control devices to operate in a user-present power consumption state may also be carried out in various ways including, for example, by allowing the thermostat to operate at the present temperature setting and not removing power to the light fixtures. That is, when the user-present power consumption state is already in operation, the controller may make no changes to the HVAC settings. Alternatively, if the environmental control devices are presently operating in the reduced power consumption state when the controller determines (208) that one or more users are present in the user space, the controller may signal the thermostat to set a predefined control temperature so as to provide HVAC operation suitable to user presence and signal the light fixture controller to provide power to one or more light fixtures.

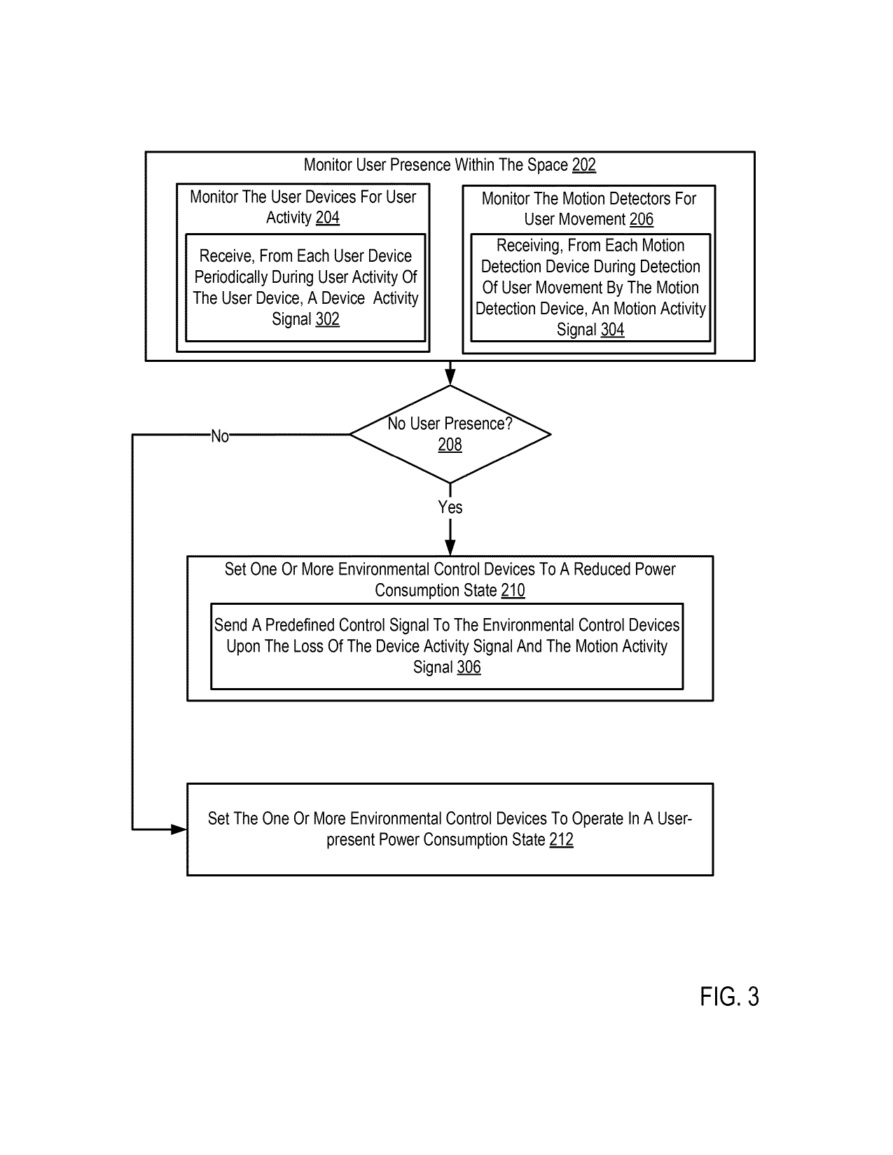

For further explanation, FIG. 3 sets forth a flow chart illustrating a further exemplary method for managing power consumption in a user space according to embodiments of the present invention. The method of FIG. 3 is similar to the method of FIG. 2 in that the method of FIG. 3 is also carried out in a user space that includes one or more user devices and one or more motion detectors. The method of FIG. 3 is also similar to the method of FIG. 2 in that the method of FIG. 3 includes monitoring (202) user presence within the space, determining (208) whether no user is present; setting (210) one or more environmental control devices to a reduced power consumption state if the user devices and motion detectors indicate no user presence within the space; and setting (212) the one or more environmental control devices to operate in a user-present power consumption state if the user devices and motion detectors indicate user presence within the space.

The method of FIG. 3 differs from the method of FIG. 2 in that in the method of FIG. 3, monitoring (204) the user devices for user activity is carried out by receiving, by a controller from each user device periodically during user activity of the user device, a device activity signal. Such a signal may be described as a ‘pulse’ or ‘heartbeat.’ When the heartbeat is present, the controller determines that user activity exists at one or more user devices. That is, a heartbeat signal represents user presence in the user space. When the heartbeat is not present, the controller determines that no user activity exists at the one or more user devices.

In the method of FIG. 3, monitoring (206) the motion detectors for user movement is carried out by receiving (304), from each motion detection device during detection of user movement by the motion detection device, a motion activity signal. Again, the motion activity signal may be in the form of a periodic ‘pulse’ or ‘heartbeat.’ When the heartbeat is present, the controller determines that one or more users are in motion in the user space as detected by one or more of the motion detectors. That is, a heartbeat signal received form a motion detector represents user presence in the user space. When the heartbeat is not present, the controller determines that no user is in motion.

Also in the method of FIG. 3, setting (306) one or more environmental control devices to a reduced power consumption state is carried out by sending (306) a predefined control signal to the environmental control devices upon the loss of the device activity signal and the motion activity signal. The predefined control signal may signal a light fixture controller to remove power from light fixtures in the user space (turning off lights) and signal a thermostat to set a predefined control temperature so as to reduce operation of the HVAC system.

In view of the explanations set forth above, readers will recognize that the benefits of managing power consumption in a user space according to embodiments of the present invention include:
Existing user spaces—such as office buildings—may be modified to manage power consumption in accordance with embodiments of the present invention at low cost, utilizing and slightly modifying equipment currently present in office buildings. Today, for example, many office buildings include motion detectors, thermostats that are networked for data communications, and many computers operating as workstations that are also networked for data communications. Modifying such an office building to operate in accordance with embodiments of the present invention may be carried out in an expensive fashion, coupling a relatively inexpensive controller to the thermostat network, the motion detectors, the computers, followed by a small software upgrade to the computers that instructs the computers to, periodically, send a signal to the controller during periods of user activity.
Providing a comprehensive method of detecting user presence in a user space, including detecting both stationary user presence and detecting mobile user presence.
Reducing energy costs related to lighting, operating HVAC systems, and so on in a relatively unoccupied office space.
Reducing energy waste related to lighting, operating HVAC systems, and so on in a relatively unoccupied office space.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of managing power consumption in a user space, the space comprising one or more user devices and one or more motion detectors, the method comprising:
monitoring user presence within the space including: monitoring the user devices for user activity, wherein user activity indicates user presence within the space; and monitoring the motion detectors for user movement, wherein user movement indicates user presence within the space;
if the user devices and motion detectors indicate no user presence within the space, setting one or more environmental control devices to a reduced power consumption state; and
if the user devices and motion detectors indicate user presence within the space, setting the one or more environmental control devices to operate in a user-present power consumption state.

2. The method of claim 1 wherein monitoring user device activity further comprises monitoring user input device activity of one or more computing devices.

3. The method of claim 1 wherein monitoring the user devices for user activity further comprises receiving, from each user device periodically during user activity of the user device, a device activity signal.

4. The method of claim 1 wherein monitoring the motion detectors for user movement further comprises receiving, from each motion detection device during detection of user movement by the motion detection device, a motion activity signal.

5. The method of claim 1 wherein:
monitoring the user devices for user activity further comprises receiving, from each user device periodically during user activity of the user device, a device activity signal;
monitoring the motion detectors for user movement further comprises receiving, from each motion detection device during detection of user movement by the motion detection device, a motion activity signal; and
setting one or more environmental control devices to a reduced power consumption state further comprises sending a predefined control signal to the environmental control devices upon the loss of the device activity signal and the motion activity signal.

6. The method of claim 1 wherein:
the environmental control devices comprise a light fixture controller and a thermostat, the light fixture controller configured to control power transmission to light fixtures, the thermostat controlling operation of an HVAC (Heating, Ventilation, and Air Conditioning) system; and
setting one or more environmental control devices to a reduced power consumption state further comprises signaling the light fixture controller to remove power from light fixtures and signaling the thermostat to set a predefined control temperature so as to reduce operation of the HVAC system.

7. An apparatus for managing power consumption in a user space, the space comprising one or more user devices and one or more motion detectors, the apparatus comprising a computer processor, a computer memory operatively coupled to the computer processor, the computer memory having disposed within it computer program instructions that, when executed, cause the apparatus to carry out the steps of:
monitoring user presence within the space including: monitoring the user devices for user activity, wherein user activity indicates user presence within the space; and monitoring the motion detectors for user movement, wherein user movement indicates user presence within the space;
if the user devices and motion detectors indicate no user presence within the space, setting one or more environmental control devices to a reduced power consumption state; and
if the user devices and motion detectors indicate user presence within the space, setting the one or more environmental control devices to operate in a user-present power consumption state.

8. The apparatus of claim 7 wherein monitoring user device activity further comprises monitoring user input device activity of one or more computing devices.

9. The apparatus of claim 7 wherein monitoring the user devices for user activity further comprises receiving, from each user device periodically during user activity of the user device, a device activity signal.

10. The apparatus of claim 7 wherein monitoring the motion detectors for user movement further comprises receiving, from each motion detection device during detection of user movement by the motion detection device, a motion activity signal.

11. The apparatus of claim 7 wherein:
monitoring the user devices for user activity further comprises receiving, from each user device periodically during user activity of the user device, a device activity signal;
monitoring the motion detectors for user movement further comprises receiving, from each motion detection device during detection of user movement by the motion detection device, a motion activity signal; and
setting one or more environmental control devices to a reduced power consumption state further comprises sending a predefined control signal to the environmental control devices upon the loss of the device activity signal and the motion activity signal.

12. The apparatus of claim 7 wherein:
the environmental control devices comprise a light fixture controller and a thermostat, the light fixture controller configured to control power transmission to light fixtures, the thermostat controlling operation of an HVAC (Heating, Ventilation, and Air Conditioning) system; and
setting one or more environmental control devices to a reduced power consumption state further comprises signaling the light fixture controller to remove power from light fixtures and signaling the thermostat to set a predefined control temperature so as to reduce operation of the HVAC system.

13. A computer program product for managing power consumption in a user space, the space comprising one or more user devices and one or more motion detectors, the computer program product disposed upon a computer readable medium, the computer program product comprising computer program instructions that, when executed, cause a computer to carry out the steps of:
monitoring user presence within the space including: monitoring the user devices for user activity, wherein user activity indicates user presence within the space; and monitoring the motion detectors for user movement, wherein user movement indicates user presence within the space;
if the user devices and motion detectors indicate no user presence within the space, setting one or more environmental control devices to a reduced power consumption state; and
if the user devices and motion detectors indicate user presence within the space, setting the one or more environmental control devices to operate in a user-present power consumption state.

14. The computer program product of claim 13 wherein monitoring user device activity further comprises monitoring user input device activity of one or more computing devices.

15. The computer program product of claim 13 wherein monitoring the user devices for user activity further comprises receiving, from each user device periodically during user activity of the user device, a device activity signal.

16. The computer program product of claim 13 wherein monitoring the motion detectors for user movement further comprises receiving, from each motion detection device during detection of user movement by the motion detection device, a motion activity signal.

17. The computer program product of claim 13 wherein:
monitoring the user devices for user activity further comprises receiving, from each user device periodically during user activity of the user device, a device activity signal;
monitoring the motion detectors for user movement further comprises receiving, from each motion detection device during detection of user movement by the motion detection device, a motion activity signal; and
setting one or more environmental control devices to a reduced power consumption state further comprises sending a predefined control signal to the environmental control devices upon the loss of the device activity signal and the motion activity signal.

18. The computer program product of claim 13 wherein:
the environmental control devices comprise a light fixture controller and a thermostat, the light fixture controller configured to control power transmission to light fixtures, the thermostat controlling operation of an HVAC (Heating, Ventilation, and Air Conditioning) system; and
setting one or more environmental control devices to a reduced power consumption state further comprises signaling the light fixture controller to remove power from light fixtures and signaling the thermostat to set a predefined control temperature so as to reduce operation of the HVAC system.

19. The computer program product of claim 13 wherein the computer readable medium comprises a storage medium.

20. The computer program product of claim 13 wherein the computer readable medium comprises a signal medium.
